(19) United States
(12) Patent Application Publication
(10) Pub. No.: US 2024/0320501 A1
(43) Pub. Date: Sep. 26, 2024

(54) RULE VISUALIZATION

(71) Applicant: Ford Global Technologies, LLC, Dearborn, MI (US)

(72) Inventors: Bilal Hejase, Columbus, OH (US); Teawon Han, San Jose, CA (US); Subramanya Nageshrao, San Jose, CA (US); Baljeet Singh, Fremont, CA (US); Tejaswi Koduri, Sunnyvale, CA (US)

(73) Assignee: Ford Global Technologies, LLC, Dearborn, MI (US)

(21) Appl. No.: 18/187,939

(22) Filed: Mar. 22, 2023

(51) Int. Cl. G06N 3/09; G06N 3/042

(52) U.S. Cl. CPC G06N 3/09; G06N 3/042

(57) ABSTRACT

A computer that includes a processor and a memory, the memory including instructions executable by the processor to train a neural network to input data and output a prediction. A policy can be generated based on the data. Force features can be generated based on the policy. Decision nodes can be trained based on force features and a binary vector from the trained neural network. A decision tree can be generated based on the decision nodes. A decision can be generated by inputting a policy to the decision tree. The decision can be compared to the prediction and the neural network re-trained based on a difference between the decision and the prediction.

### BACKGROUND

Images can be acquired by sensors and processed using a computer to determine data regarding objects in an environment around a system. Operation of a sensing system can include acquiring accurate and timely data regarding objects in the system's environment. A computer can acquire images from one or more image sensors that can be processed to determine data regarding objects. Data extracted from images of objects can be used by a computer to operate systems including vehicles, robots, security systems, and/or object tracking systems.

### BRIEF DESCRIPTION OF THE DRAWINGS

FIG. 1 is a block diagram of an example vehicle sensing system.

FIG. 2 is a diagram of an example neural network system.

FIG. 3 is a diagram of an example neural network explanation system.

FIG. 4 is a diagram of an example traffic scene.

FIG. 5 is a diagram of an example decision tree.

FIG. 6 is a diagram of an example decision node.

FIG. 7 is a diagram of an example traffic force.

FIG. 8 is a diagram of two other example traffic forces.

FIG. 9 is a diagram of four other example traffic forces.

FIG. 10 is a flowchart diagram of an example process to determine a neural network explanation system.

FIG. 11 is a flowchart diagram of an example process to operate a vehicle based on a neural network.

### DETAILED DESCRIPTION

A system as described herein can be used to locate objects in an environment around the system and may operate the system based on the location of the objects. Typically, sensor data can be provided to a computer to locate an object and determine a system trajectory based on the location of the object. A trajectory is a set of locations that can be indicated as coordinates in a coordinate system along with velocities, e.g., vectors indicating speeds and headings, at the respective locations. A trajectory can be determined at least in part based on a categorical variable that provides a system with directions indicated by a phrase; based on a categorical variable, a computer in a system can determine a trajectory for operating the system that locates the system or portions of the system with respect to the object. For example, a categorical variable can direct a vehicle to “PARK” and based on the categorical variable a computer can determine one or more trajectories that operate the vehicle so cause the vehicle to move into a parking spot. A vehicle is described herein as a non-limiting example of a system that includes a sensor to acquire data regarding an object, a computer to process the sensor data and controllers to operate the vehicle based on output from the computer. Other systems that can include sensors, computers and controllers that can respond to objects in an environment around the system include robots, security systems and object tracking systems.

In an example system that can input sensor data, locate objects, and operate a device, the sensor data can be processed using a neural network. A neural network can input data, perform operations on the data and output predictions regarding the input data. A neural network is trained by inputting a training dataset that includes ground truth that indicates a correct prediction for the input data. Training a neural network includes processing the input dataset a large number of times while comparing the resulting predictions to the ground truth. Parameters that govern the calculations performed by the neural network, called weights, can be adjusted as the dataset is being processed to reduce a loss function, which indicates a difference between the prediction and the ground truth to a minimal value.

Once trained, a neural network can input data, detect objects, and determine output(s). For example, a neural network in a robot system can detect objects on a conveyer belt and output a location for the part along with a categorical variable such a “PICK UP PART”. Based on the categorical variable and the object location, a computer can determine a trajectory for a robot arm to pick the object off the conveyer belt and place it in a bin. A neural network in a security system can detect a person and output a categorical variable that instructs a computer to lock or unlock doors as appropriate. A vehicle can determine the location and velocity of other vehicles in an environment around a vehicle and output categorical variables that can be used by a computer to determine one or more trajectories for the vehicle. An issue with neural networks is that they operate as a “black box.” The neural network inputs data and outputs predictions with little visibility as to how the prediction was arrived at. Neural networks can include decision results as latent variables. Latent variables are unlabeled and are typically not output to provide insight as to the internal state of the neural network.

Techniques discussed herein determine explanations, referred to herein as explanation systems, for how neural networks are arriving at results. For example, an explanation system can describe the envelope within which a robot will be moving in response to specific inputs in applications where humans are in the same environment. An explanation system can describe the conditions under which a security system will erroneously identify a stray animal as an intruder. An explanation system can describe the conditions under which a vehicle guidance system will decide when to make a lane change in response to a traffic situation. Vehicle guidance will be used as a non-limiting example of explanation systems herein.

Explanation systems as discussed herein can enhance the operation of a vehicle guidance neural network by generating a hierarchical rule-based system that describes the operation of a neural network in terms that a human can understand. By modeling the operation of a neural network as a series of nodes that embody decision rules in a binary tree structure, the predictions output by a neural network can be understood as a series of decision rules. The decision rules can be expressed in a visual fashion using AND/OR logic to describe complex decision-making. The visual expression of the AND/OR logic can be interpreted by a human observer to explain complex behavior of the vehicle guidance neural network. Interpretation of the complex behavior of the vehicle guidance neural network can enhance the operation of the vehicle guidance neural network by determining first ranges of traffic scenarios in which the vehicle guidance neural network makes decisions determined to be acceptable to human interpretation and second ranges of traffic scenarios in which the vehicle guidance neural network makes decisions determined to be unacceptable to human interpretation.

Examples of decisions made by a vehicle guidance neural network that can be determined to be unacceptable to human interpretation can include decisions that cause a vehicle to exceed user-determined limits on lateral or longitudinal acceleration, e.g., stopping or changing lanes too quickly. In examples where a vehicle guidance system makes decisions that are unacceptable to human interpretation, the operation of the vehicle guidance system can be enhanced by adding additional hardware and software to recognize the unacceptable decisions and prevent the vehicle from being operated based on the unacceptable decisions. In other examples the vehicle guidance neural network can be re-trained to eliminate or reduce the unacceptable decisions. In either example the operation of the vehicle guidance neural network can be enhanced by operation of an explanation system as discussed herein.

Explaining complex behavior of a vehicle guidance neural network can enhance the operation of the vehicle guidance neural network by predicting the behavior of the vehicle guidance neural network in terms of predicted input conditions. For example, driving force diagrams derived from an explanation decision tree can indicate how a vehicle guidance neural network would respond to vehicles in an environment around the vehicle that includes the vehicle guidance neural network. The ability to predict the behavior of a vehicle guidance neural network can enhance user confidence that the neural network will make appropriate decisions. Output from an explanation system may be used to document compliance with government or industry performance standards. Output from an explanation system can also be used to analyze the behavior of a vehicle guidance neural network and determine data that can be used to train the neural network for enhanced performance.

Disclosed herein is a method, including training a neural network to input data and output a prediction, generating a policy based on the data, generating force features based on the policy and training decision nodes based on force features and a binary vector from the trained neural network. A decision tree can be generated based on the decision nodes. A decision can be generated by inputting the policy to the decision tree and comparing the decision to the prediction. The neural network can be re-trained based on a difference between the decision and the prediction. The decision tree can be determined based on user input. The decision nodes can be second neural networks. The decision nodes can be trained using supervised learning based on a binary vector output from the trained neural network and the force features based on the policy.

The decision nodes can determine rules in disjunctive normal form. The decision nodes can output binary values. The trained neural network can input data and output predictions regarding categorical variables that are directives usable for determining a trajectory. The trained neural network can be output to a second computer in a vehicle and the trajectory can be used to operate the vehicle. The force features can be combined into a surface plot. The prediction output from the neural network can be compared to the surface plot. The input data can be an image. The policy can be a traffic policy. The force features can be traffic force features. The traffic force features can include repulsive forces between vehicles.

Further disclosed is a computer readable medium, storing program instructions for executing some or all of the above method steps. Further disclosed is a computer programmed for executing some or all of the above method steps, including a computer apparatus, programmed to train a neural network to input data and output a prediction, generate a policy based on the data, generate force features based on the policy and train decision nodes based on force features and a binary vector from the trained neural network. A decision tree can be generated based on the decision nodes. A decision can be generated by inputting the policy to the decision tree and comparing the decision to the prediction. The neural network can be re-trained based on a difference between the decision and the prediction. The decision tree can be determined based on user input. The decision nodes can be second neural networks. The decision nodes can be trained using supervised learning based on a binary vector output from the trained neural network and the force features based on the policy.

The instructions can include further instructions wherein decision nodes can determine rules in disjunctive normal form. The decision nodes can output binary values. The trained neural network can input data and output predictions regarding categorical variables that are directives usable for determining a trajectory. The trained neural network can be output to a second computer in a vehicle and the trajectory can be used to operate the vehicle. The force features can be combined into a surface plot. The prediction output from the neural network can be compared to the surface plot. The input data can be an image. The policy can be a traffic policy. The force features can be traffic force features. The traffic force features can include repulsive forces between vehicles.

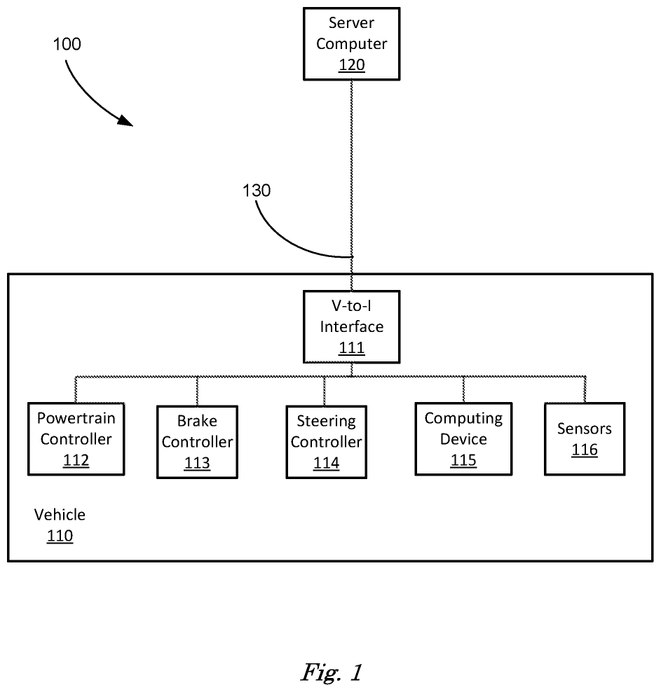

FIG. 1 is a diagram of a sensing system 100 that can include a server computer 120. Sensing system 100 includes a vehicle 110, operable in autonomous (“autonomous” by itself in this disclosure means “fully autonomous”), semi-autonomous, and/or occupant piloted (also referred to as non-autonomous) modes, as discussed in more detail below. One or more vehicle 110 computing devices 115 can receive data regarding the operation of the vehicle 110 from sensors 116. The computing device 115 may operate the vehicle 110 in an autonomous mode, a semi-autonomous mode, or a non-autonomous mode.

The computing device 115 includes a processor and a memory such as are known. Further, the memory includes one or more forms of computer-readable media, and stores instructions executable by the processor for performing various operations, including as disclosed herein. For example, the computing device 115 may include programming to operate one or more of vehicle brakes, propulsion (i.e., control of acceleration in the vehicle 110 by controlling one or more of an internal combustion engine, electric motor, hybrid engine, etc.), steering, climate control, interior and/or exterior lights, etc., as well as to determine whether and when the computing device 115, as opposed to a human operator, is to control such operations.

The computing device 115 may include or be communicatively coupled to, i.e., via a vehicle communications bus as described further below, more than one computing devices, i.e., controllers or the like included in the vehicle 110 for monitoring and/or controlling various vehicle components, i.e., a propulsion controller 112, a brake controller 113, a steering controller 114, etc. The computing device 115 is generally arranged for communications on a vehicle communication network, i.e., including a bus in the vehicle 110 such as a controller area network (CAN) or the like; the vehicle 110 network can additionally or alternatively include wired or wireless communication mechanisms such as are known, i.e., Ethernet or other communication protocols.

Via the vehicle network, the computing device 115 may transmit messages to various devices in the vehicle and/or receive messages from the various devices, i.e., controllers, actuators, sensors, etc., including sensors 116. Alternatively, or additionally, in cases where the computing device 115 actually comprises multiple devices, the vehicle communication network may be used for communications between devices represented as the computing device 115 in this disclosure. Further, as mentioned below, various controllers or sensing elements such as sensors 116 may provide data to the computing device 115 via the vehicle communication network.

In addition, the computing device 115 may be configured for communicating through a vehicle-to-infrastructure (V2X) interface 111 with a remote server computer 120, i.e., a cloud server, via a network 130, which, as described below, includes hardware, firmware, and software that permits computing device 115 to communicate with a remote server computer 120 via a network 130 such as wireless Internet (WI-FI®) or cellular networks. V2X interface 111 may accordingly include processors, memory, transceivers, etc., configured to utilize various wired and/or wireless networking technologies, i.e., cellular, BLUETOOTH®, Bluetooth Low Energy (BLE), Ultra-Wideband (UWB), Peer-to-Peer communication, UWB based Radar, IEEE 802.11, and/or other wired and/or wireless packet networks or technologies. Computing device 115 may be configured for communicating with other vehicles 110 through V2X (vehicle-to-everything) interface 111 using vehicle-to-vehicle (V-to-V) networks, i.e., according to including cellular communications (C-V2X) wireless communications cellular, Dedicated Short Range Communications (DSRC) and/or the like, i.e., formed on an ad hoc basis among nearby vehicles 110 or formed through infrastructure-based networks. The computing device 115 also includes nonvolatile memory such as is known. Computing device 115 can log data by storing the data in nonvolatile memory for later retrieval and transmittal via the vehicle communication network and a vehicle to infrastructure (V2X) interface 111 to a server computer 120 or user mobile device 160.

As already mentioned, generally included in instructions stored in the memory and executable by the processor of the computing device 115 is programming for operating one or more vehicle 110 components, i.e., braking, steering, propulsion, etc., without intervention of a human operator. Using data received in the computing device 115, i.e., the sensor data from the sensors 116, the server computer 120, etc., the computing device 115 may make various determinations and/or control various vehicle 110 components and/or operations without a driver to operate the vehicle 110. For example, the computing device 115 may include programming to regulate vehicle 110 operational behaviors (i.e., physical manifestations of vehicle 110 operation) such as speed, acceleration, deceleration, steering, etc., as well as tactical behaviors (i.e., control of operational behaviors typically in a manner intended to achieve efficient traversal of a route) such as a distance between vehicles and/or amount of time between vehicles, lane-change, minimum gap between vehicles, left-turn-across-path minimum, time-to-arrival at a particular location and intersection (without signal) minimum time-to-arrival to cross the intersection.

Controllers, as that term is used herein, include computing devices that typically are programmed to monitor and/or control a specific vehicle subsystem. Examples include a propulsion controller 112, a brake controller 113, and a steering controller 114. A controller may be an electronic control unit (ECU) such as is known, possibly including additional programming as described herein. The controllers may communicatively be connected to and receive instructions from the computing device 115 to actuate the subsystem according to the instructions. For example, the brake controller 113 may receive instructions from the computing device 115 to operate the brakes of the vehicle 110.

The one or more controllers 112, 113, 114 for the vehicle 110 may include known electronic control units (ECUs) or the like including, as non-limiting examples, one or more propulsion controllers 112, one or more brake controllers 113, and one or more steering controllers 114. Each of the controllers 112, 113, 114 may include respective processors and memories and one or more actuators. The controllers 112, 113, 114 may be programmed and connected to a vehicle 110 communications bus, such as a controller area network (CAN) bus or local interconnect network (LIN) bus, to receive instructions from the computing device 115 and control actuators based on the instructions.

Sensors 116 may include a variety of devices known to provide data via the vehicle communications bus. For example, a radar fixed to a front bumper (not shown) of the vehicle 110 may provide a distance from the vehicle 110 to a next vehicle in front of the vehicle 110, or a global positioning system (GPS) sensor disposed in the vehicle 110 may provide geographical coordinates of the vehicle 110. The distance(s) provided by the radar and/or other sensors 116 and/or the geographical coordinates provided by the GPS sensor may be used by the computing device 115 to operate the vehicle 110 autonomously or semi-autonomously, for example.

The vehicle 110 is generally a land-based vehicle 110 capable of autonomous and/or semi-autonomous operation and having three or more wheels, i.e., a passenger car, light truck, etc. The vehicle 110 includes one or more sensors 116, the V2X interface 111, the computing device 115 and one or more controllers 112, 113, 114. The sensors 116 may collect data related to the vehicle 110 and the environment in which the vehicle 110 is operating. By way of example, and not limitation, sensors 116 may include, i.e., altimeters, cameras, LIDAR, radar, ultrasonic sensors, infrared sensors, pressure sensors, accelerometers, gyroscopes, temperature sensors, pressure sensors, hall sensors, optical sensors, voltage sensors, current sensors, mechanical sensors such as switches, etc. The sensors 116 may be used to sense the environment in which the vehicle 110 is operating, i.e., sensors 116 can detect phenomena such as weather conditions (precipitation, external ambient temperature, etc.), the grade of a road, the location of a road (i.e., using road edges, lane markings, etc.), or locations of target objects such as neighboring vehicles 110. The sensors 116 may further be used to collect data including dynamic vehicle 110 data related to operations of the vehicle 110 such as velocity, yaw rate, steering angle, engine speed, brake pressure, oil pressure, the power level applied to controllers 112, 113, 114 in the vehicle 110, connectivity between components, and accurate and timely performance of components of the vehicle 110.

Vehicles can be equipped to operate in autonomous, semi-autonomous, or manual modes, as stated above. By a semi- or fully-autonomous mode, we mean a mode of operation wherein a vehicle can be piloted partly or entirely by a computing device as part of a system having sensors and controllers. For purposes of this disclosure, an autonomous mode is defined as one in which each of vehicle propulsion (i.e., via a propulsion including an internal combustion engine and/or electric motor), braking, and steering are controlled by one or more vehicle computers; in a semi-autonomous mode the vehicle computer(s) control(s) one or more of vehicle propulsion, braking, and steering. In a non-autonomous mode, none of these are controlled by a computer. In a semi-autonomous mode, some but not all of them are controlled by a computer.

Server computer 120 typically has features in common, i.e., a computer processor and memory and configuration for communication via a network 130, with the vehicle 110 V2X interface 111 and computing device 115, and therefore these features will not be described further to reduce redundancy. A server computer 120 can be used to develop and train software that can be transmitted to a computing device 115 in a vehicle 110.

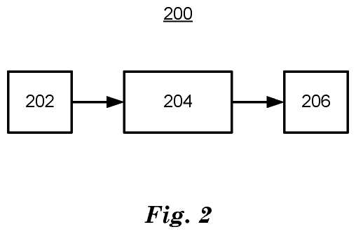

FIG. 2 is a diagram of a vehicle guidance neural network system 200. Vehicle guidance neural network system 200 can be developed and trained on a server computer 120 and transmitted to a computing device 115 included in a vehicle 110. Vehicle guidance neural network system 200 can input an image 202 generated by vehicle sensors 116 to a neural network 204 which outputs predictions 206 which include categorical variables that can be used for determining vehicle 110 trajectories. For example, vehicle sensor data can include images 202 of the environment around a vehicle 110 as it travels on a roadway. Neural network 204 can process the images 202 and output predictions 206 which include vehicle categorical variables. A categorical variable is an output variable that can assume a value from a list of phrases. For example, possible vehicle trajectory categorical variables can include, “TURN LEFT”, “TURN RIGHT”, “SLOW DOWN”, “SPEED UP”, “STOP”, “LEFT LANE CHANGE,” and “RIGHT LANE CHANGE”, etc.

The predictions 206 can include categorical variables that that reduce contact with vehicles in roadway lanes around the vehicle 110, maintains vehicle lateral and longitudinal accelerations within predetermined lower and upper limits, and operates the vehicle within applicable traffic regulations. The predictions 206 include categorical variables can be used to operate the vehicle 110 by determining one or more trajectories based on the categorical variables. A computing device 115 can receive the categorical variable as input and determine a trajectory that can be used to operate the vehicle 110 so as to accomplish the vehicle maneuver indicated by the categorical variable. The trajectory determined based on the categorical variable can be used by computing device 115 to transmit commands to controllers 112, 113, 114 to control vehicle propulsion, steering and braking, respectively to operate vehicle 110 so as to travel on the predicted trajectory.

Neural network 204 can be a convolutional neural network that includes a plurality of convolutional layers that input image data and convolve the image data with convolutional kernels that extract features from the image data. The extracted features can be passed as hidden or latent variables to a plurality of fully connected layers that detect objects such as vehicles in the hidden or latent variables and output predictions 206. Predictions 206 can include categorical variables that indicate trajectories that can include directions and speeds for operating a vehicle 110. For example, a prediction 206 can include a categorical variable such as “LEFT LANE CHANGE” or “RIGHT LANE CHANGE” to indicate trajectories that include directions and speeds to accomplish a lane change maneuver for a vehicle 110. Neural network 204 can be trained to predict categorical variables for operating a vehicle by inputting images 202 of traffic scenes to assemble a training dataset of images 202 that include objects such as nearby vehicles along with ground truth for the images 202. Ground truth includes predictions 206 for the images 202 in the training dataset determined to be appropriate by a human observer.

A human observer can observe images 202 of a traffic scene that indicate the locations and speeds of other vehicles around a vehicle 110 and determine an appropriate operation for a vehicle 110. For example, if a set of images 202 indicate that a vehicle 110 is approaching a leading vehicle in the same lane traveling a lower speed than the vehicle 110, images 202 that describe the locations and speeds of vehicles in adjacent traffic lanes can be observed to determine whether a vehicle 110 should slow down to match the speed of the leading vehicle or change lanes to the left or right. The training dataset can include many thousands of images 202 and corresponding ground truth data.

At training time, images 202 from the training dataset are passed through the neural network 204 to generate predictions 206 a plurality of times. Each time an image 202 is passed through the neural network 204, the output prediction 206 is compared with the ground truth for that image 202 and a loss function determined. A loss function typically measures the difference between an output prediction 206 and the ground truth, with the goal being to minimize the difference. The loss function can be minimized by back projecting the loss function through the neural network 204. Back projection is a technique for selecting the weights which program each layer of the neural network from back (output) to front (input). The weights which result in the minimal value of the loss function for the greatest number of input images 202 in the training dataset are selected as the weights to be used in the trained neural network 204.

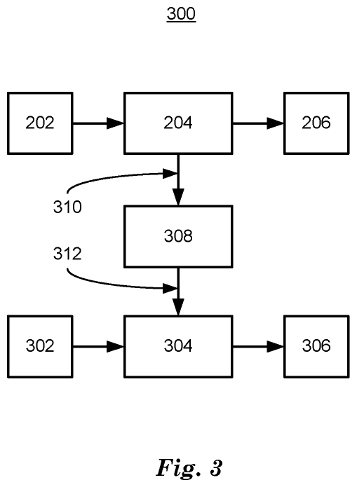

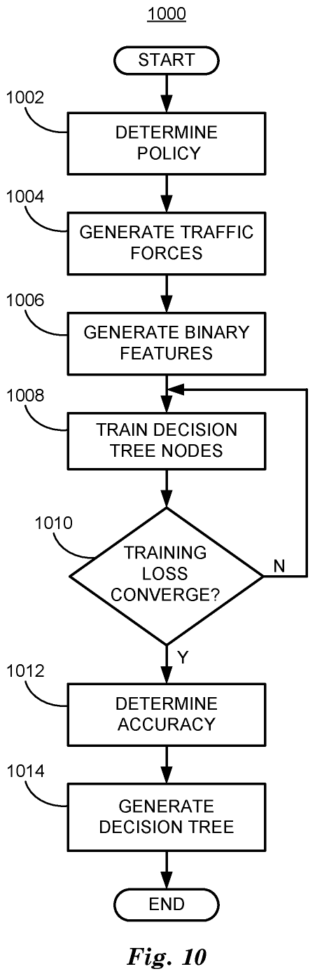

FIG. 3 is a diagram of an explanation system 300. Explanation system 300 begins with a trained neural network 204, that receives input images 202 and outputs predictions 206 as described above in relation to FIG. 2. In addition to outputting predictions 206, trained neural network outputs features 310 to decision rules extraction 308. Features 310 are values of latent variables generated by trained neural network 204 that indicate locations and velocities of vehicles included in an input image 202. Decision rules extraction 308 encodes each feature 310 as a binary “one hot vector.” One hot vectors are binary vectors 312, e.g., vectors that include only 1s or 0s as values and which encodes the value of a feature as a 1 at a unique position in a binary vector. Binary vectors 312 output from decision rules extraction 308 are input to decision rules model 304. Decision rules extraction 308 determines a binary vector 312 having 1s at locations indicating feature 310 values to decision rules model 304. Decision rules model 304 receives binary vectors 312 and combines them as discussed below in relation to FIG. 10 to form decision rules that are included in decision trees.

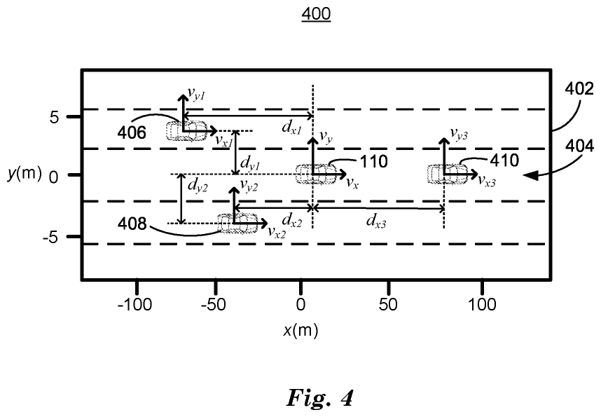

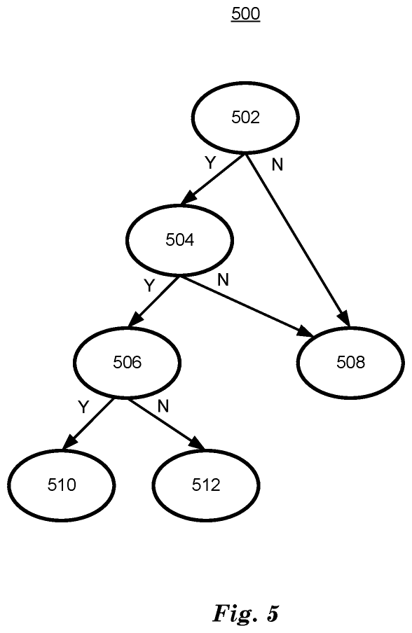

Decision rules model 304 can input a traffic policy 302. A traffic policy 302 is a list of relationships between a vehicle 110 and other vehicles in an environment around a vehicle. Determining a traffic policy 302 from a diagram of a traffic scene is described in relation to FIG. 4, below. Decision rules model 304 receives as input a traffic policy and outputs decision rules 306 that apply to the input traffic policy 302. Because the decision rules 306 were determined based on features 310 output from a trained neural network 204, the decision rules 306 can be used to explain the prediction 206 output by the trained neural network 204. Decision rules 306 are logical equations expressed in disjunctive normal form. Disjunctive normal form is a logical equation in AND/OR form equivalent to a sum-of-products, where subsets of a set of logical values are first ANDed together and then the ANDed values are ORed to form a result. Disjunctive normal equations are discussed in relation to FIG. 5, below. Transforming binary vectors 312 into decision rules 306 is discussed in relation to FIG. 10, below.

FIG. 4 is a diagram illustrating a traffic scene 400. Traffic scene 400 includes a roadway 402 that includes traffic lanes 404 indicated by dashed lines. Traffic scene 400 is graphed on x, y axes measured in meters, where the x axis designates the longitudinal direction with respect to the roadway 402 and the y axis designates the lateral direction with respect to the roadway 402. Traffic scene 400 can be analyzed to yield traffic forces. A list of traffic forces determined based on a traffic scene 400 is referred to herein a traffic policy 302. Traffic forces are the locations and velocities of vehicles 110, 406, 408, 410 included in a traffic scene 400. The locations and velocities can be determined relative to a vehicle 110 that includes the trained neural network 204 that will be determining predictions 206 that include categorical variables that indicate vehicle trajectories that will be used to operate vehicle 110. Traffic forces include relative x and y locations of vehicles 406, 408, 410 with respect to vehicle 110 and relative x and y velocities of vehicle 406, 408, 410 with respect to vehicle 110. Traffic policy 302 includes the location of a vehicle 110 including velocities in the x and y directions vₓ and v_{y} respectively, denoted by the labeled arrows. Traffic policy 302 also includes locations of vehicles 406, 408, 410 along with x and y velocities denoted by the arrows labeled vₓ₁, v_{y1}, vₓ₂, v_{y2}, vₓ₃, and v_{y3} attached to the vehicles 406, 408, 410. Also included in traffic policy 302 are x and y distances dₓ₁, d_{y1}, dₓ₂, d_{y2} and dₓ₃ for vehicles 406, 408, 410, respectively, measured from vehicle 110. Traffic policy 302 includes the values for vehicle 406, 408, 410 distances dₓ₁, d_{y1}, dₓ₂, d_{y2} and dₓ₃ relative to vehicle 110 and vehicle 406, 408, 410 velocities vₓ₁, v_{y1}, vₓ₂, v_{y2}, vₓ₃, and v_{y3} relative to vehicle 110.

The distances and velocities determined based on a traffic scene 400 can be combined to determine a traffic policy 302. A traffic policy 302 includes the relationships between a vehicle 110, and the vehicles 406, 408, 410 around the vehicle 110. The distances and velocities included in a traffic policy 302 can be input to a decision rules model 304 to determine decision rules 306 that describe the operation of a vehicle 110 based on the input traffic policy 302. For example, possible decision rules 306 that can be output from a decision rules model 304 based on a traffic policy 302 determined based on a traffic scene 400 can include “NO LANE CHANGE”, “LEFT LANE CHANGE,” and “RIGHT LANE CHANGE”. The decision rule 306 output from decision rules model 304 based on a traffic policy 302 depends upon the distance and velocity values included in traffic policy 302.

FIG. 5 is a diagram of a decision tree 500. A decision tree 500 can be constructed based on user input regarding relationships between traffic policies 302 and decision rules 306. Relationships between traffic policies 302 and decision rules 306 is referred to herein as domain knowledge. Domain knowledge includes data about human understanding regarding the relationships between traffic policies 302 and decision rules 306 along with observations of human drivers operating vehicles 110. Decision rules 306 included in domain knowledge include acceptable vehicle operations that can be performed by a vehicle 110 in response to traffic policies 302. Acceptable vehicle operations are vehicle operations that include lateral and longitudinal accelerations within user-determined limits, that maintain user-determined distances from other vehicles, and conform to applicable traffic laws, such as speed limits, etc. Domain knowledge includes decision rules 306 that indicate commonly understood vehicle maneuvers including starting, stopping, lane keeping, lane changes, obeying traffic signs and signals, etc. Domain knowledge includes relationships between traffic policies 302 and decision rules 306.

Decision trees 500 are constructed to embody domain knowledge for operation of a vehicle in traffic. Decision trees 500 input traffic policies 302 and output decision rules 306 that include acceptable vehicle operations based on the input traffic policy 302. Traffic polices 302 and decision trees 500 are grouped according to the number and types of decision rules 306 possible as outputs to determine to which decision tree 500 a particular traffic policy 302 should be input. Decision trees are designed as a tree structure that includes decision nodes 502, 504, 506 that break the response to a traffic policy 302 down into a series of binary decisions and output binary values indicating the binary decision. A binary decision is a decision that answers a question with an “either/or” or “yes/no” choice between two possible results. Decision trees 500 also include output nodes 508, 510, 512 that include decision rules 306 to be output in response to an input traffic policy 302.

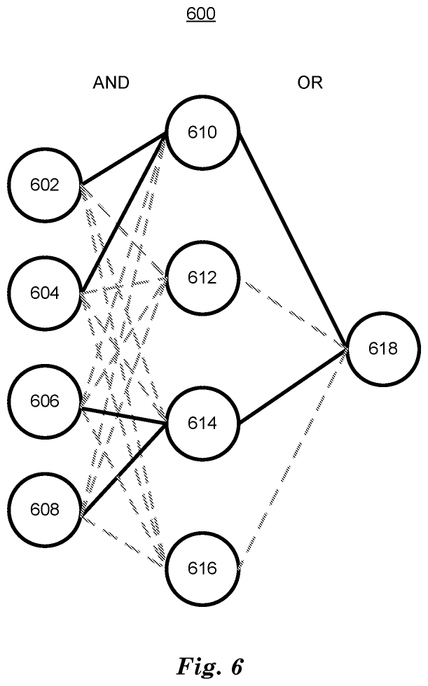

Decision rules model 304 includes decision trees 500 that each include a plurality of decision nodes 502, 504, 506 and output nodes 508, 510, 512. Decision nodes 502, 504, 506 included in decision trees 500 are trained by selecting values from a binary vector 312 output from a trained neural network 204. Binary values from the binary vector 312 are used to determine disjunctive normal expressions by comparing the results output from the output nodes 508, 510, 512 with predictions 206 output from the trained neural network 204. The process of determining the disjunctive normal expression is iterated until the output from the output nodes 508, 510, 512 matches the predictions 206 output from a trained neural network 204. The trained decision nodes 502, 504, 506 are combined with output nodes 508, 510, 512 to form decision trees 500. Training decision nodes 502, 504, 506 is discussed in relation to FIG. 6, below. A process 1000 for determining decision nodes 502, 504, 506 based on input from a trained neural network 204 is illustrated in FIG. 10.

Decision tree 500 is an example that indicates decisions to be made in determining whether or not to make a lane change. The decision nodes 502, 504, 506 include disjunctive normal expressions as discussed in relation to FIG. 6, below that input data from a traffic policy 302 and determine binary decisions, which, when combined as demonstrated by decision tree 500 output decision rules 306 regarding lane changes in response to an input traffic policy 302. The output nodes 508, 510, 512 indicate decision rules 306. Each decision node 502, 504, 506 includes a decision rule neural network as described in relation to FIG. 6 which inputs data from an input traffic policy 302 and makes a binary (YES or NO) decision based on data included in the traffic policy 302.

In this example, the decision tree 500 can be executed when a traffic policy 302 is input that indicates a lane change is possible. A lane change can be indicated when a traffic policy 302 includes a forward or x-direction velocity vₓ for a vehicle 110 that is greater than the velocity of a leading vehicle 410 in the same lane and ahead of the vehicle 110, and the traffic policy 302 data indicates that the vehicle 110 is traveling on a roadway that includes one or more adjacent traffic lanes 404, for example. The decision node 502 of the decision tree can input data from the traffic policy 302 that includes data regarding the distance dₓ₃ to a leading vehicle 410 and the velocity difference between the vehicle 110 velocity vₓ and the leading vehicle velocity vₓ₃. If the velocity difference and distance indicate that vehicle 110 will become closer to leading vehicle 410 than a user-determined distance, decision node 502 will take the “YES” branch to “AVAILABLE LANE” decision node 504. If the velocity and distance values input to decision node 502 indicate that vehicle 110 will maintain a distance greater than the user-determined minimum distance, the “NO” branch will be taken to “NO LANE CHANGE” node 508.

At “AVAILABLE LANE” decision node 504, data from traffic policy 302 regarding distances and velocities for left and right lane vehicles 406, 408 is input to determine if the traffic lanes 404 adjacent to vehicle 110 are available for a lane change. If one or more of the lanes are available, decision tree 500 takes the “YES” branch to “LEFT LANE FREE” node 506. If neither of the adjacent lanes are free, decision tree 500 takes the “NO” branch to the “NO LANE CHANGE” node 508.

At “LEFT LANE FREE” node 506, traffic policy 302 data regarding the velocity and distance of vehicle 406 in the left lane adjacent to vehicle 110 are evaluated to determine whether vehicle 110 can make a lane change into the adjacent left lane while maintaining a distance to vehicle 406 greater than a user-determined minimum. If vehicle 110 can make the lane change to the left lane, decision tree takes the “YES” branch to “LEFT LANE CHANGE” node 510. “LEFT LANE CHANGE” node 510 outputs a decision rule 306 to make a lane change into the left lane adjacent to vehicle 110. If vehicle 110 cannot make a lane change into the left lane, decision tree 500 takes the “NO” branch to “RIGHT LANE CHANGE” node 512. “RIGHT LANE CHANGE” node 512 outputs a decision rule 306 to make a lane change into the right lane adjacent to vehicle 110. Following nodes 508, 510, and 512, decision tree 500 ends.

FIG. 6 is a diagram of an example decision node 600. Decision nodes 600 are second neural networks that combine input nodes 602, 604, 606, 608 using AND or NOT AND functions and output to decision nodes 610, 612, 614, 616. That is, a decision node 600 calculates disjunctive normal logical equations and outputs binary values. Decision nodes 600 are connected together to form decision trees 500 to determine decision rules 306 based on input traffic policies 302. The decision nodes 610, 612, 614, 616 are combined using OR or NOT OR functions to output results 618.

Determining decision nodes 600 includes human input to determine logical equations that indicate which binary values included in a binary vector 312 are included in which decision rule 306. As discussed above in relation to FIG. 3, the decision rules 306 are logical equations that each output a binary value that selects which branch of a decision node 600 to take. Determining decision rules 306 includes determining which binary values included in a binary vector 312 should be included in a disjunctive logical equation that can be evaluated to determine a binary decision.

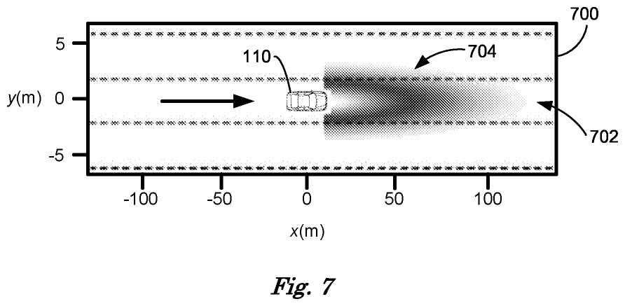

A decision node 600 is evaluated by inputting values included in the binary vector 312 to input nodes 602, 604, 606, 608. The output from input nodes 602, 604, 606, 608 are combined by a plurality of disjunctive normal logical equations to obtain output results 618. The output results are applied to traffic force graphs determined as illustrated in FIGS. 7-9 to form a loss function. The loss function can be minimized by stochastic gradient descent on the loss function. Stochastic gradient descent is a technique for determining which disjunctive logical equations determine the lowest loss based on the binary vectors output from a neural network 204. Determining rules in disjunctive normal form based on binary vector 312 and traffic force graphs using stochastic gradient descent is discussed in “Learning Accurate and Interpretable Decision Rule Sets from Neural Networks”, Litao Qiao, Weijia Wang, and Bill Lin, Proceedings of the AAAI Conference on Artificial Intelligence, 35(5), 4303-4311 May 18, 2021.

An example of a disjunctive normal logical equation D is given by:

$$D = ( {a}_{1} ∧ {a}_{2} ) ⋁ ( {a}_{1} ∧ {a}_{3} ) ⋁ ( {a}_{4} ∧ {a}_{5} ∧ {a}_{6} ) \qquad ( 1 )$$

Where a₁ . . . aₙ are the logical elements to be combined and ∧ and ∨ are the symbols for the AND and OR operations, respectively. Disjunctive normal equations included in decision nodes 600 can be linked to inputs from traffic policies 302 during training. Binary values included in binary vectors 312 are determined by input images 202 which can be analyzed to determine which data included in a traffic policy 302 is indicated by binary values included in a binary vector 312.

Decision node 600 is an example of a decision node 600 that can be included in a lane change decision tree 500. In this example, decision node 600 can be labeled “AVAILABLE LANE” as discussed above in relation to FIG. 5. Other decision nodes 600 can be trained and labeled as discussed above in relation to FIG. 5 and combined with output nodes 508, 510, 512 to complete decision tree 500. A decision rules model 304 includes plurality of decision trees 500 that input data from traffic policies 302 and output decision rules 306 that match predictions 206 output from trained neural network 204. Data from a traffic policy 302 is input to decision rules model 304 to select a decision tree 500. The data included in the traffic policy 302 are input to the disjunctive normal equations included in the decision nodes 600 of the selected decision tree 500 to determine which decision rules 306 to output.

In this example, decision node 600 calculates the “AVAILABLE LANE” function of decision node 504 of decision tree 500. Data from a binary vector 312 that indicates velocities and distances between vehicles can be input to input nodes 602, 604, 606, 608. For example, input node 602 can include a binary value of “TRUE if the difference in velocity (vₓ−vₓ₁>a) between vehicle 110 and vehicle 406 is greater than a user selected value a. Input node 604 can include a binary value of “TRUE” if the distance (dₓ₁>b), where b is a user selected minimum distance. Likewise, input node 606 can include a binary value based on the difference in velocity (vₓ−vₓ₂>a) between vehicle 110 and vehicle 408. Input node 608 can include a binary value based on the distance (dₓ₂>b), where b is a user selected minimum distance.

Output from input nodes 602 and 604 are ANDed to form the expression ((vₓ−vₓ₁)∧(dₓ₁>a)) which is output to decision node 610 indicated by the solid lines connecting nodes 602, 604, 610. Outputs from input nodes 606 and 608 are ANDed to form the expression ((vₓ−vₓ₂)∧(dₓ₂>a)) which is output to decision node 614 indicated by the solid lines connecting nodes 606, 608, 614. Lighter dashed lines indicate potential connections not used to determine this expression. Outputs from decision nodes 610, 614 are ORed together to form the expression ((vₓ−vₓ₁)∧(dₓ₁>a)∨(vₓ−vₓ₂)∧(dₓ₂>a)) which is output to output node 618. Output node 618 indicates a value of “TRUE” or “YES” if the disjunctive normal binary expression ((vₓ−vₓ₁)∧(dₓ₁>a)∨(vₓ−vₓ₂)∧(dₓ₂>a)) evaluates to “TRUE”. If the disjunctive normal binary expression ((vₓ−vₓ₁)∧(dₓ₁>a)∨(vₓ−vₓ₂)∧(dₓ₂>a)) evaluates to “FALSE”, output node 618 outputs “FALSE” or “NO”. In this fashion, decision nodes 600 can be combined in decision rules model 304 to determine decision rules 306 based on input traffic policies 302

Decision rules 306 output by decision rules model 304 can enhance operation of a vehicle 110 by a trained neural network 204 by providing human-understandable explanations for predictions 206 output by a neural network 204. Decision rules 306 permit insight into the “black box” processing that a neural network 204 performs. For example, examining decision rules 306 output by decision rules model 304 can determine categorical variables included in predictions 206 would cause distances between vehicle to be less that a user selected distance and eventually result in contact between a vehicle 110 and another vehicle.

In a real world example where contact between a vehicle 110 and another vehicle occurred, examining decision rules 306 could be used to assign liability. If the decision rule prevents a vehicle 110 from maneuvering so as to cause contact, vehicle 110 cannot be at fault, for example. Examining decision rules 306 could be used to determine compliance with regulations regarding autonomous or semi-autonomous operation of a vehicle 110 by a trained neural network 204. Decision rules 306 can indicate categorical variables that indicate trajectories that would result in possible unacceptable vehicle 110 operation such as excessive lateral or longitudinal accelerations or causing contact between vehicle 110 and another vehicle. Decision rules 306 that indicate possible unacceptable vehicle 110 operation can indicate images 202 and ground truth that can be used to re-train a neural network 204 to reduce generating unacceptable predictions 206.

FIG. 7 is a diagram of traffic force graph 700. Diagraming a traffic policy 302 as a traffic force graph 700 can enhance understanding of traffic policies 302. A traffic force features graphs 700 is a graphic illustration of the traffic policies 302 input to decision trees to determine decision rules 306. Traffic force graph 700 includes a repulsive x-force 704. Repulsive x-force 704 is a graphic device that uses a dimensionless quantity to illustrate traffic rules that recommend minimum separation between vehicles. Traffic force graphs 700 illustrate vehicle separation as intensity, where darker intensity indicates less separation. Overlaid on a traffic scene 400, traffic force features can indicate desired separation between vehicles and can indicate unacceptable vehicle operations. For example, a vehicle trajectory based on a categorical variable included in a prediction 206 output from a trained neural network 204 can be overlaid on a traffic force graph 700 to indicate an unacceptable traffic maneuver by a vehicle 110.

Traffic force graph 700 includes a roadway 702 including traffic lanes (dashed lines). Traffic force graph 700 plots lateral distance y(m) in meters on the y-axis and longitudinal distance x(m) in meters on the x-axis. Vehicle 110 is traveling on roadway 702 in the direction indicate by the arrow. Traffic force graph 700 illustrates a portion of traffic policy 302 as a repulsive x-force 704 indicated by the shaded region in front of vehicle 110. The shaded region of repulsive x-force 704 indicates the degree to which other vehicles 406, 408, 410 are repelled from vehicle 110 by traffic policy 302. The darker the shaded region, the greater the repulsive force. Repulsive x-force is determined by the equation:

$${F}_{rep , x} = {\sum }_{j} {e}^{- \frac{{( x + 50 )}^{2}}{2 {σ}_{x}}} ( x + 50 ) {e}^{- \frac{{y}^{2}}{2 {σ}_{y}}} \qquad ( 2 )$$

Where x, y are longitudinal and lateral positions measured with respect to vehicle 110, j is an index assigned to detected vehicles 406, 408, 410 around vehicle 110 and σₓ=2000, σ_{y}=3 are the user selected force variances and the constant 50 is used to translate the peak repulsive force to be at the center of vehicle 110.

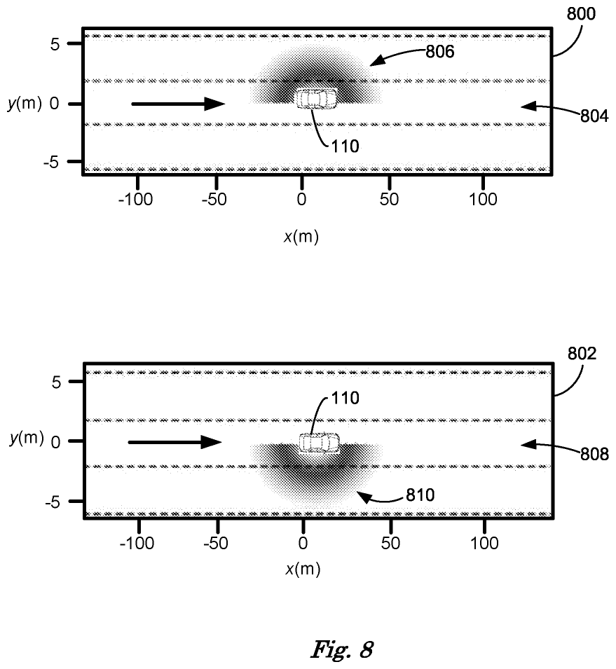

FIG. 8 is a diagram of traffic force graphs 800, 802. Traffic force graphs 800, 802 includes roadways 804, 808, respectively including traffic lanes (dashed lines). Traffic force graphs 800, 802 plot lateral distance y(m) in meters on the y-axis and longitudinal distance x(m) in meters on the x-axis. Vehicle 110 is traveling on roadways 804, 808 in the directions indicate by the arrows. Traffic force graphs 800, 802 illustrate portions of traffic policy 302 as repulsive y-forces 806, 810 indicated by the shaded region to the left and right of vehicle 110. Repulsive y-forces 806, 810 indicate repulsive forces with which other vehicles 406, 408, 410 are repelled from vehicle 110 by traffic policy 302. Repulsive force measures the influence another vehicle 406, 408, 410 has on a vehicle 110. Repulsive force is a probability that a vehicle would exceed predetermined minimum distance between vehicles and eventually contact the other vehicle. Repulsive y-forces are determined by the equations:

$${F}_{repy , l} = {e}^{- \frac{{x}^{2}}{2 {σ}_{x , Y}}} {e}^{- \frac{{y}^{2}}{2 {σ}_{y , Y}}} u ( y \geq 0 ) \qquad ( 3 )$$

$${F}_{repy , r} = {e}^{- \frac{{x}^{2}}{2 {σ}_{x , Y}}} {e}^{- \frac{{y}^{2}}{2 {σ}_{y , Y}}} u ( y < 0 ) \qquad ( 4 )$$

Where F_{repy,l} is the repulsive force to the left of vehicle 110 and F_{repy,r} is the repulsive force to the right of vehicle 110 and u( ) is a step function, i.e., u(x)=1 if x>0 else u(x)=0.

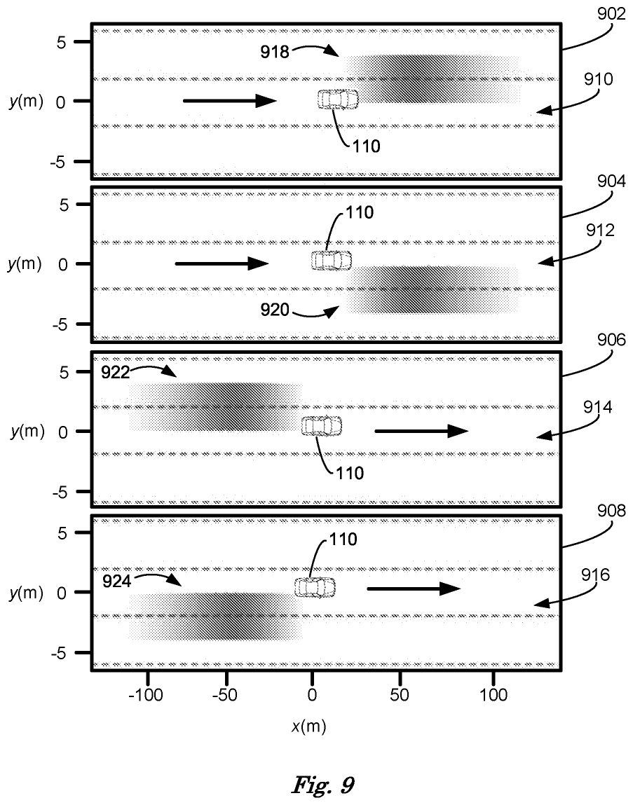

FIG. 9 is a diagram of traffic force graphs 902, 904, 906, 908. Traffic force graphs 902, 904, 906, 908 includes roadways 910, 912, 914, 916, respectively including traffic lanes (dashed lines). Traffic force graphs 902, 904, 906, 908 plot lateral distance y(m) in meters on the y-axis and longitudinal distance x(m) in meters on the x-axis. Vehicle 110 is traveling on roadways 910, 912, 914, 916 in the directions indicate by the arrows. Traffic force graphs 902, 904, 906, 908 illustrate traffic policy 302 as repulsive lane change forces 918, 920, 922, 924 indicated by the shaded region to the front left and right and rear left and right of vehicle 110 respectively. Repulsive lane change forces 918, 920, 922, 924 indicate the degree to which other vehicles 406, 408, 410 are repelled from vehicle 110 by portions of traffic policy 302. Repulsive lane change forces are determined by the equations:

$${F}_{repx , fl} = {\sum }_{j} {e}^{- \frac{{( x + 50 )}^{2}}{2 {σ}_{x}}} ( x + 50 ) u ( x ) u ( 0 < y \leq 4 ) \qquad ( 5 )$$

$${F}_{repx , fr} = {\sum }_{j} {e}^{- \frac{{( x + 50 )}^{2}}{2 {σ}_{x}}} ( x + 50 ) u ( x ) u ( - 4 < y \leq 0 ) \qquad ( 6 )$$

$${F}_{repx , rl} = - {\sum }_{j} {e}^{- \frac{{( x - 50 )}^{2}}{2 {σ}_{x}}} ( x - 50 ) u ( - x ) u ( 0 < y \leq 4 ) \qquad ( 7 )$$

$${F}_{repx , rr} = {\sum }_{j} {e}^{- \frac{{( x - 50 )}^{2}}{2 {σ}_{x}}} ( x - 50 ) u ( x ) u ( - 4 < y \leq 0 ) \qquad ( 8 )$$

Where F_{repx,fl} is the front-left lane change force 918, F_{repx,fr} is the front-right lane change force 920, F_{repx,rl} is the rear-left lane change force 922, and F_{repx,rr} is the rear-right lane change force 924.

In addition to the x-force 704, y-forces 806, 810, and lane change forces 918, 920, 922, 924 a following force for vehicles trailing vehicle 110 in the same lane can be determined by the equation:

$${F}_{v} = \frac{{v}_{d} - {v}_{x}}{{V}_{max} - {V}_{min}} \qquad ( 9 )$$

Where v_{d} is the desired velocity, vₓ is the current vehicle 110 velocity, and Vₘₐₓ, Vₘᵢₙ are the maximum and minimum velocities permitted for vehicle 110 on the current roadway. Each vehicle 406, 408, 410 in the environment around vehicle 110 can have a following force determined according to equation 9. Determining velocity following forces for vehicles 406, 408, 410 in around a vehicle 110 permits velocity-based metrics to be used to determine traffic forces in addition to the distance-based metrics illustrated in equations (2)-(8).

The traffic force graphs 700, 800, 802, 902, 904, 906, 908 can be combined to form a surface plot and populated with vehicles 110, 406, 408, 410 to explain predictions 206 output by neural network 204. Predictions 206 output from a neural network 204 can be compared with the surface plot. For example, predictions 206 output from a neural network 204 can be overlaid on this surface plot to determine whether the prediction 206 is consistent with the traffic force graphs 700, 800, 802, 902, 904, 906, 908. For example, if a prediction 206 would indicate operating vehicle 110 so as to cause an overlap between traffic force graphs 700, 800, 802, 902, 904, 906, 908 and one or more vehicles 406, 408, 410, the output from decision rules model 304 would not match the prediction 206 output from neural network 204. The neural network 204 can be re-trained to cause the prediction 206 to match the decision rules 306 output from the decision rules model 304.

FIG. 10 is a flowchart, described in relation to FIGS. 1-9 of a process 1000 for determining a neural network 204 decision rules model 304. Process 1000 can be implemented by a processor of a server computer 120, taking as input traffic policies 302 and outputting traffic decision rules 306. Process 1000 includes multiple blocks that can be executed in the illustrated order. Process 1000 could alternatively or additionally include fewer blocks or can include the blocks executed in different orders.

Process 1000 begins at block 1002 where a server computer 120 generates a plurality of traffic policies 302 based on sampling images 202 from a training dataset used to train a neural network 204. Images 202 included in a training dataset can be processed using a neural network to determine a traffic scene 400 that can be analyzed to generate the plurality of traffic policies 302. As discussed in relation to FIG. 4, above, the plurality of traffic policies 302 include vehicle locations and velocities for vehicles 406, 408, 410 in an environment around a vehicle 110. The environment typically includes a roadway 402 including traffic lanes 404.

At block 1004 server computer 120 generates traffic forces based on distances and velocities of vehicles included in the plurality of traffic policies 302. Traffic forces include repulsive forces between vehicles 406, 408, 410 and vehicle 110, for example. Determining traffic forces is discussed in relation to FIGS. 7-9, above.

At block 1006 server computer 120 generates binary features included in a binary vector 312 based on latent variables included in a neural network 204 based on processing the input images 202 The binary vector 312 encodes the distances and velocities between vehicles 406, 408, 410 and vehicle 110 that neural network 204 uses to determine whether to output “LEFT LANE CHANGE”, “RIGHT LANE CHANGE” or “STAY IN LANE”, for example. The data included in the binary vector 312 is used to determine the decision rules 306 included in decision nodes 600 that are included in decision trees 500.

At block 1008 server computer 120 trains decision nodes 600 by comparing the decisions output from a decision tree 500 with the categorical variables output from neural network 204 to determine a loss function. This is referred to a supervised learning. The loss function measures how closely the categorical variables output from a decision tree 500 match the categorical variables output from a neural network 204 as predictions 206. The decisions output from a decision tree 500 can sum the collective losses from a plurality of input images 202. The loss function can be determined by scoring a match between the categorical variable output from a decision tree 500 and the neural network 204 as a “0” and scoring a mismatch between the decision tree 500 output and the neural network 204 as a “1”. If the loss functions from of a plurality of input images 202 are summed, a lower loss function indicates that the categorical variables output by decision tree 500 output are matching the categorical variables output from the neural network 204.

At block 1010 server computer 120 examines the loss functions determined at block 1008 and determines whether the decision rules 306 output by decision nodes 600 are converging to the predictions 206 output from neural network 204. Convergence is measured by comparing the summed loss functions to a user-determined threshold. The summed loss functions are proportional to the percentage of decision rules 306 that mis-match categorical variables output as predictions 206. The threshold can be selected to determine the percentage of decision rules 306 that can mismatch predictions 206, typically about 1%. If the training loss is not converging, e.g., reaching a user-determined threshold minimal value, process 1000 loops back to block 1008 to adjust disjunctive logical equations input to decision nodes 600. If the training loss is converging, e.g., reaching a user-determined threshold minimal value, process 1000 passes to block 1012.

At block 1012, the categorical variables output by decision nodes 600 are compared to categorical variables output as predictions 206 by the neural network 204 to determine and overall accuracy of the decision nodes 600 by summing loss functions for each decision node 600. Assuming that the overall loss function is below an overall user-determined threshold. The disjunctive logical equations determined for each decision node 600 can be saved as the final versions.

At block 1014 decision nodes 600 are combined to form decision trees 500 as discussed in relation to FIG. 5, above. The output from decision trees 500 and traffic force graphs 700, 800, 802, 902, 904, 906, 908 can be used to explain the categorical variables output as predictions 206 from neural network 204. Examination of decision rules 306 output from decision rules model 304 can explain to a human observer why a neural network 204 outputs a particular categorical variable in response to a particular input image 202. For example, if, in a given traffic scenario, the neural network 204 tends to output a categorical variable that places a vehicle 110 too close to another vehicle, the training dataset and the ground truth included in the training dataset can be changed to respond differently. Examination of the categorical variables output from a neural network 204 by comparing them to traffic force graphs 700, 800, 802, 902, 904, 906, 908 can indicate output predictions 206 that violate traffic rules or place vehicles too closely. Based on examination of the categorical variables output as predictions 206 with respect to decision rules 306 and traffic force graphs 700, 800, 802, 902, 904, 906, 908, a decision can be made whether to deploy a neural network 204 to a computing device 115 in a vehicle 110 or re-train neural network 204 on server computer 120. An example that would require re-training neural network 204 could be the neural network 204 outputting a prediction 206 that would result in a trajectory that caused vehicle 110 to operate so as to exceed limits on lateral or longitudinal accelerations as indicated by traffic force graphs 700, 800, 802, 902, 904, 906, 908. Following block 1014 process 1000 ends.

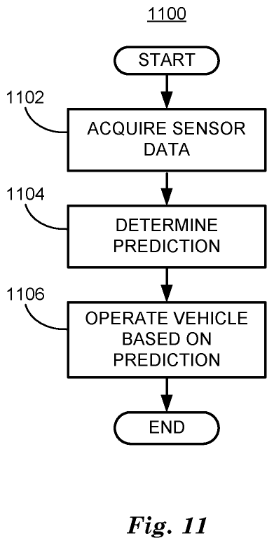

FIG. 11 is a flowchart, described in relation to FIGS. 1-10 of a process 1100 for operating a vehicle 110 based on predictions 206 output from a neural network 204. Neural network 204 is trained as described above in relation to FIGS. 2-10 and transmitted from a server computer 120 to a computing device 115 included in a vehicle 110. Because the neural network 204 has been trained using an explanation system 300, neural network 204 can be installed in a vehicle 110 with confidence that predictions 206 output from the neural network 204 will result in vehicle 110 operations that are explainable to human interpretation as described herein. Process 1100 can be implemented by a processor of a computing device 115, taking as input data from vehicle sensors 116 and outputting predictions 206 which are used by computing device 115 to operate vehicle 110. Process 1100 includes multiple blocks that can be executed in the illustrated order. Process 1100 could alternatively or additionally include fewer blocks or can include the blocks executed in different orders.

Process 1100 begins at block 1102 where a computing device 115 acquires data from vehicle sensors 116. The data can be image data that is processed by computing device 115, using one or more second neural networks, for example, to determine locations and velocities of vehicles 406, 408, 410 with respect to vehicle 110.

At block 1104 the acquired and processed sensor 116 data is input to a trained neural network 204 to determine a prediction 206. The prediction 206 can be output as a categorical variable that directs the operation of the vehicle 110. For example, the categorical variables can include “STOP”, “REDUCE SPEED TO XX MPH”. “LEFT LANE CHANGE”, etc. as described above.

At block 1106 computing device 115 inputs the categorical variable output from neural network 204 and processes the categorical variable to operate the vehicle 110. Typically, the computing device 115 determines a vehicle path which, when operated upon, causes the vehicle 110 to accomplish the operation described in the categorical variable. A vehicle path can be a polynomial function that describes predicted speeds and directions from the current location of the vehicle 110 to another location. The vehicle path can be determined by the computing device 115 to maintain minimum and maximum lateral and longitudinal accelerations, for example. The vehicle path can be processed by computing device 115 to determine commands to output to controllers 112, 113, 114 to control vehicle propulsion, steering, and brakes to operate the vehicle 110 along the vehicle path while achieving the speed and directions indicated by the vehicle path. Because neural network 204 was trained using an explanation system 300, the vehicle paths determined based on predictions 206 output from neural network 204 will be consistent with traffic force graphs 700, 800, 802, 902, 904, 906, 908, for example. Following block 1106 process 1100 ends.

Computing devices such as those discussed herein generally each includes commands executable by one or more computing devices such as those identified above, and for carrying out blocks or steps of processes described above. For example, process blocks discussed above may be embodied as computer-executable commands.

Computer-executable commands may be compiled or interpreted from computer programs created using a variety of programming languages and/or technologies, including, without limitation, and either alone or in combination, Java™, C, C++, Python, Julia, SCALA, Visual Basic, Java Script, Perl, HTML, etc. In general, a processor (i.e., a microprocessor) receives commands, i.e., from a memory, a computer-readable medium, etc., and executes these commands, thereby performing one or more processes, including one or more of the processes described herein. Such commands and other data may be stored in files and transmitted using a variety of computer-readable media. A file in a computing device is generally a collection of data stored on a computer readable medium, such as a storage medium, a random access memory, etc.

A computer-readable medium (also referred to as a processor-readable medium) includes any non-transitory (i.e., tangible) medium that participates in providing data (i.e., instructions) that may be read by a computer (i.e., by a processor of a computer). Such a medium may take many forms, including, but not limited to, non-volatile media and volatile media. Instructions may be transmitted by one or more transmission media, including fiber optics, wires, wireless communication, including the internals that comprise a system bus coupled to a processor of a computer. Common forms of computer-readable media include, for example, RAM, a PROM, an EPROM, a FLASH-EEPROM, any other memory chip or cartridge, or any other medium from which a computer can read.

All terms used in the claims are intended to be given their plain and ordinary meanings as understood by those skilled in the art unless an explicit indication to the contrary in made herein. In particular, use of the singular articles such as “a,” “the,” “said,” etc. should be read to recite one or more of the indicated elements unless a claim recites an explicit limitation to the contrary.

The term “exemplary” is used herein in the sense of signifying an example, i.e., a candidate to an “exemplary widget” should be read as simply referring to an example of a widget.

The adverb “approximately” modifying a value or result means that a shape, structure, measurement, value, determination, calculation, etc. may deviate from an exactly described geometry, distance, measurement, value, determination, calculation, etc., because of imperfections in materials, machining, manufacturing, sensor measurements, computations, processing time, communications time, etc.

In the drawings, the same candidate numbers indicate the same elements. Further, some or all of these elements could be changed. With regard to the media, processes, systems, methods, etc. described herein, it should be understood that, although the steps or blocks of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claimed invention.

1. A system, comprising:
a computer that includes a processor and a memory, the memory including instructions executable by the processor to:
train a neural network to input data and output a prediction;
generate a policy based on the data;
generate force features based on the policy;
train decision nodes based on force features and a binary vector from the trained neural network;
generate a decision tree based on the decision nodes;
generate a decision by inputting the policy to the decision tree;
compare the decision to the prediction; and
re-train the neural network based on a difference between the decision and the prediction.

2. The system of claim 1, wherein the decision tree is determined based on user input.

3. The system of claim 1, wherein the decision nodes are second neural networks.

4. The system of claim 1, wherein the decision nodes are trained using supervised learning based on a binary vector output from the trained neural network and the force features based on the policy.

5. The system of claim 1, wherein the decision nodes determine rules in disjunctive normal form.

6. The system of claim 1, wherein the decision nodes output binary values.

7. The system of claim 1, wherein the trained neural network inputs data and outputs predictions regarding categorical variables that are directives usable for determining a trajectory.

8. The system of claim 7 wherein the trained neural network is output to a second computer in a vehicle and the trajectory is used to operate the vehicle.

9. The system of claim 1, the instructions including further instructions to combine the force features into a surface plot.

10. The system of claim 9, the instructions including further instructions to compare the prediction output from the neural network to the surface plot.

11. A method, comprising:
training a neural network to input data and output a prediction;
generating a policy based on the data;
generating force features based on the policy;
training decision nodes based on force features and a binary vector from the trained neural network;
generating a decision tree based on the decision nodes;
generating a decision by inputting the policy to the decision tree;
comparing the decision to the prediction; and
re-training the neural network based on a difference between the decision and the prediction.

12. The method of claim 11, wherein the decision tree is determined based on user input.

13. The method of claim 11, wherein the decision nodes are second neural networks.

14. The method of claim 11, wherein the decision nodes are trained using supervised learning based on a binary vector output from the trained neural network and the force features based on the policy.

15. The method of claim 11, wherein the decision nodes determine rules in disjunctive normal form.

16. The method of claim 11, wherein the decision nodes output binary values.

17. The method of claim 11, wherein the trained neural network inputs data and outputs predictions regarding categorical variables that are directives usable for determining a trajectory.

18. The method of claim 17, wherein the trained neural network is output to a second computer in a vehicle and the trajectory is used to operate the vehicle.

19. The method of claim 11, further comprising combining the force features into a surface plot.

20. The method of claim 19, further comprising comparing the prediction output from the neural network to the surface plot.
